(19) United States
(12) Patent Application Publication
(10) Pub. No.: US 2001/0053739 A1
(43) Pub. Date: Dec. 20, 2001

(54) HIGH THERMAL CONDUCTIVITY ALN FOR MICROWAVE TUBE APPLICATIONS

(76) Inventor: BILJANA MIKIJELJ, CERRITOS, CA (US)

Correspondence Address: LEONARD TACHNER, A PROFESSIONAL LAW, CORPORATION, 17961 SKY PARK CIRCLE, SUITE 38-E, IRVINE, CA, 92614

(21) Appl. No.: 09/419,884

(22) Filed: Oct. 18, 1999

(51) Int. Cl. C04B 35/00

(52) U.S. Cl. 501/98.4; 501/98.5

(57) ABSTRACT

Dense, high thermal conductivity AIN ceramic is described (along with a method of manufacture) which can be used in microwave tubes as collector rods, Helix support rods, T rods, etc. instead of BeO ceramic. High thermal conductivity, vacuum compatibility, low dielectric loss tangent at microwave frequencies, high electrical resistivity and dielectric strength are AIN properties allowing the material to be used in traveling wave tubes, particle accelerators or as laser bores and in other similar applications. These materials allow the replacement of BeO, which is a toxic material with diminishing availability in the United States and on the world market.

### BACKGROUND OF THE INVENTION

1. Field of the Invention

The present invention relates generally to the field of ceramic materials and more specifically to an AIN material having properties simulating the high thermal conductivity, lossy dielectric properties of materials comprising toxic BeO.

2. Prior Art

Coupled cavity, Traveling-wave tubes and Klystron microwave amplification tubes (manufactured by companies like Hughes, Varian (CPI), Litton, EEV, etc.) in most cases need to employ BeO ceramics as collector rods, helix support rods, T Rods, etc., which are required to efficiently dissipate heat from the tube. Traditionally, BeO ceramics have been most commonly used in this application, due to its high thermal conductivity and thermal stability, vacuum compatibility and low dielectric loss characteristics. However, due to the toxicity of the material (causing Chronic Beryllia Disease), the number of suppliers of BeO is very limited. In addition, the use of BeO components in microwave tubes requires safety warnings on tubes and special disposal handling as hazardous waste. Due to this, an alternate material with similar combination of properties of BeO is required.

Although high thermal conductivity AIN has been developed as a substrate material (0.020-0.050″ thick), it has not been recognized that the properties of AIN offer a unique replacement for BeO in microwave tubes and as a laser bore material.

There is therefore a need to design the AIN material to have all of the following characteristics so that it can be used to replace BeO ceramics:

1. Material dielectric loss tangent less than 0.02 in the microwave frequency region;

2. Material thermal conductivity of over 140 W/m K;

3. Material strength to be comparable;

4. Material to be capable of sustaining high vacuum environments of microwave tubes;

5. Material capable of withstanding thermal cycling during the manufacture and tube assembly.

### SUMMARY OF THE INVENTION

According to the present invention, a material formed of aluminum nitride (AIN) with additions of small amounts of Y₂O₃, other metal or rare earth oxides is shown to have the above properties. Materials produced according to the invention have thermal conductivities of over 140 W/mk at room temperature, and can exceed BeO at higher temperatures. The material can be densified using hot pressing, gas-pressure or pressureless sintering in a protective atmosphere.

An important aspect of the invention is the recognition that certain AIN properties are similar to properties of BeO and allow it to be used to replace BeO in microwave tubes.

### OBJECTS OF THE INVENTION

It is therefore a principal object of the present invention to provide a material which has the high thermal conductivity and dielectric loss tangent characteristics useful in the fabrication of microwave tubes.

It is another object of the invention to provide a material which may be used as a substitute for materials having toxic BeO which has become virtually unavailable because of the dangers of Chronic Beryllia Disease.

It is still another object of the invention to provide a material which closely simulates the high thermal conductivity and low dielectric loss characteristics of BeO, but without the dangerous toxicity of BeO.

### DETAILED DESCRIPTION OF A PREFERRED EMBODIMENT

According to the present invention, an aluminum nitride (AIN) is provided which is formed by hot pressing, gas-pressure sintering or pressureless sintering. Mixed powders of aluminum nitride in the presence of a sintering aid, such as Y₂O₃, CaO, Li₂O, La₂O₃, Sm₂O₃, Gd₂O₃ or other rare earth metal oxides or mixtures thereof are formed by dry pressing (or isostatic pressing, injection molding or other similar methods know to those familiar with the art). Consolidation at high temperatures (and or pressures) to a virtually dense material with densities of over 95%, preferably higher than 97% of theoretical density, can be accomplished by hot pressing, hipping, gas-pressure sintering or pressureless sintering (including microwave sintering). A controlled inert atmosphere of nitrogen is preferred, however Ar can also be used as well in some cases.

The sintering aid content (Y₂O₃, CaO, Li₂O, La₂O₃, Sm₂O₃, Gd₂O₃ and earth metal oxides or mixtures thereof) are effective in promoting densification and thermal conductivity in the 0.25-10% wt. range, preferably in the 0.5-5% wt. range. AIN powder with surface areas of over 1 m²/g are required for hot pressing, with higher surface areas than 3 m²/g required for sintering. Sintering aids powder (Y₂O₃ or other) preferably have a surface area over 5 m²/g, preferably over 8 m²/g.

Several different samples of the material comprising mixed AIN and Y₂O₃ powders were formed using varying percentages of Y₂O₃, Sm₂O₃, Gd₂O₃, etc. Commercially available AIN and rare earth oxide powders were used. Powder mixing was accomplished using standard mixing techniques in a non-aqueous medium (isopropyl alcohol, hexane or similar). Powder was then dried, homogenized and screened. (Binders can be added to the powder and the powder can be spray dried if required without deviating from the teachings of the invention.) Powder batching can also be done in an aqueous medium provided the AIN powder surface is deactivated using an appropriate surfactant. The powder was then poured into a steel 4×4″ die and uniaxially pressed to form a billet.

The billets were assembled into a graphite hot press die and loaded into a hot pressure furnace. The billets were hot pressed in an inert nitrogen atmosphere at a range of temperatures from 1600-1950 degrees Celsius and with applied pressures of 1000-4000 psi, with the pressure application starting at approximately 1600 degrees Celsius to 1850 degrees Celsius, preferably 1700-1850 degrees Celsius. The heating rates are dependent on the furnace and the load size and temperature holds in the 1650-1750 degrees Celsius range are preferable in order to densify the material.

Table 1 presents the results of some of the runs performed and it shows the thermal conductivities obtained with the materials and their densities.

TABLE 1
Thermal Conductivities and densities Measured on hot pressed AIN
materials

| | Maximum HP | | |
|---|---|---|---|
| | Temperature | Thermal | Relative Density |
| | (Degrees | Conductivity, | (% |
| Composition | Celsius)/Ref# | RT (W/mK) | Theoretical) |
| AIN-3w % Y₂O₃ | 1750 (99#2-18-4) | 155 | 99.5 |
| AIN-3w % Y₂O₃ | 1775 (99#2-11-4) | 154 | 99.4 |
| AIN-3w % Y₂O₃ | 1800 (99#1-5-4) | 154 | 99.5 |
| AIN-5w % Y₂O₃ | 1800 (99#1-1-4) | 177 | 99.5 |
| AIN-5w % Y₂O₃ | 1850 | 177 | 99.3 |
| | (99#12-14-4) | | |
| AIN-4w % Y₂O₃ | 1840 (99#5-17) | 141 | 99.9 |
| | Pillar 99041 | | |
| AIN-4w % Y₂O₃ | 1825 (99#3-36) | 138 | 99.9 |
| AIN-5w % Y₂O₃ | 1825 (99#3-36) | 144 | 99.9 |
| AIN-5w % Y₂O₃ | 1840 (99#8-2) | 190 | 99.6 |
| AIN-4w % | 1820 Degrees | 142 | 99.3 |
| Gd₂O₃ | Celsius (99#8-9) | | |
| AIN-4w % | 1820 Degrees | 139 | 99.2 |
| Sm₂O₃ | Celsius (99#8-9) | | |
| AIN-4w % | 1820 Degrees | 144 | 99.4 |
| Nd₂O₃ | Celsius (99#8-9) | | |
| AIN-4w % Er₂O₃ | 1820 Degrees | 139 | 99.2 |
| | Celsius (99#8-9) | | |

Measured dielectric constant of AIN—4% Y₂O₃ at 1.5 GHz was 7.7 with a loss tangent of 0.0085. ASTM C1161 MOR bar strength of material AIN—3% Y₂O₃ was 300 MPA.

As can be seen from the Table 2, properties of BeO can be closely reproduced with AIN. These AIN materials have thermal conductivities of at least 140 w/mK at room temperature (Table 1), and are likely to have equivalent or higher conductivities than BeO at temperatures over ˜200 degrees Celsius (Table 2). AIN has superior mechanical and dielectric strength as compared to BeO. Further optimization of these properties is possible within the framework of this invention and includes optimizing firing conditions, composition and powder grades and particle size.

TABLE 2
Property Comparison - AIN vs. BeO

| Property | AIN | BeO |
|---|---|---|
| Density (g/cm³) | 3.27 | 2.86 |
| Melting Point (Degrees | ˜2300¹ | 2530 |
| Celsius) | | |
| Flexural Strength (Mpa) | 250-350 | 150-200 |
| Hardness, HK.5 (kg/mm²) | 1200 | 1000 |
| Modulus of Elasticity | 316 | 380 |
| (Gpa) | | |
| Thermal Conductivity | 90-200 | 200-260 |
| (W/m K.) | | |
| @ RT | | |
| @ 200 Degrees Celsius | 70-160 | 120-140 |
| Thermal Expansion | 4.3 | 8.3 |
| Coefficient (10⁻⁶ 1/K.) | | |
| Dielectric Constant | 8.6 | 6.7 |
| @ 1 MHZ | | |
| Dielectric Strength | 15 | 10 |
| (KV/mm) | | |
| Volume Resistivity | >10¹³ | >10¹³ |
| (Ohm.cm) | | |

¹AIN sublimes at ambient atmospheric conditions.

Selected AIN compositions of the present invention have been brazed to Cu successfully demonstrating the material has adequate strength. Furthermore, low porosity of the material (high theoretical density) allows the material to sustain high vacuum requirements without outgassing after precision machining into components and after adequate cleaning/conditioning.

The present invention demonstrates that:

1. AIN material can be manufactured to closely match thermal properties of BeO materials;

2. AIN can be manufactured to have thermal conductivities over 140 W/mK, by using optimized amounts of sintering aids;

3. Dense AIN can be manufactured consistently by hot pressing or sintering AIN powders with appropriate sintering;

4. AIN manufacture according to this invention has more than sufficient strength to enable ceramic to metal bonding to Cu or other metals;

5. Due to its low porosity levels (high densities) the AIN materials are vacuum compatible.

### Compositions

AIN—90-99.8% by weight.

Y₂O₃, La₂O₃, Sm₂O₃, Gd₂O₃, Er₂O₃ other rare earth oxides, CaO, Li₂O or combination thereof—0.25-10% by weight.

### Consolidation Methods

Hot Pressing, Hipping, Gas Pressure and Pressureless Sintering (including microwave sintering)

### Methodology

Powder batch preparation and mixing

The above mentioned powders, or powders which will yield the final composition described above after firing, are homogeneously mixed using conventional ceramic powder batching techniques (ball milling, dry or in a slurry, high shear mixing, spray drying, etc.). In case of slurry mixing, appropriate solvent is used to prevent the hydrolysis of AIN powder (alcohols, hexane, etc.). Water can also be used if the AIN powder surfaces are de-activated by an appropriate hydrophobic surfactant. Binders are added to the powder during mixing as necessary, but are not required.

### 2. Part Forming

Parts are formed using standard powder consolidation techniques: dry pressing, iso-pressing, slip casting, tape casting, gel casting, etc.

### 3. Densification (Sintering)

The final dense material is obtained by simultaneous application of heat and pressure to the parts (hot pressing, hipping, gas-pressure sintering) or by only heating the parts in non-oxidizing, inert atmosphere (Ar, Nitrogen, etc.). The sintering temperature range is 1650-1950 degrees Celsius preferably 1700-1850 degrees Celsius.

### Properties

High thermal conductivity

High strength

Brazeability

High density (vacuum compatibility)

### Applications

1. Collector rods, Helix support rods, T rods, etc. material for microwave tube industry and particle accelerators facilities.

2. Laser Bore material.

Having thus disclosed preferred embodiments of the inventive material and methods of its fabrication, it being understood that variations in the material and method of manufacture are contemplated, what is claimed is:

1. A material fabricated for use in microwave tubes to substantially simulate the dielectric properties and thermal conductivity of BeO; the material comprising:
a composite formed of a matrix of AIN and a sintering aid;
the AIN exceeding 90% of said composition by weight, the sintering aid comprising up to about 10% of said composition by weight;
said material being formed by homogeneously mixing said AIN and said sintering aid in powder form, consolidating said mixture and densifying said consolidated mixture.

2. The material recited in claim 1 wherein homogeneously mixing is performed using at least one powder batching process taken from the group consisting of dry ball milling, slurry ball milling or high shear mixing and spray drying.

3. The material recited in claim 1 wherein consolidating said mixture is performed using at least one powder consolidating process taken from the group consisting of dry pressing, iso-pressing, slip casting, tape casting and gel casting.

4. The material recited in claim 1 wherein densifying said consolidated mixture is performed using at least one sintering process taken from the group consisting of hot pressing, hipping, gas-pressure sintering, microwave sintering and ambient pressure heating in a non-oxidizing inert atmosphere.

5. The material recited in claim 1 wherein said sintering aid is taken from the group consisting of Y₂O₃, La₂O₃, Sm₂O₃, Gd₂O₃ other rare earth oxides, CaO, Li₂O and combinations thereof.

6. The material recited in claim 1 wherein said sintering aid comprises between 0.25% and 10% of said composition by weight.

7. A material for use in microwave tubes and comprising:
aluminum nitride and a sintering aid;
the aluminum nitride comprising at least 90% of said composition by weight, said sintering aid comprising up to about 10% of said composition by weight;
said composition being formed by mixing said aluminum nitride and sintering aid in powder form, consolidating said mixture and densifying said consolidated mixture to a relative density of at least 99% of theoretical.

8. The microwave tube material recited in claim 7 wherein said sintering aid is taken from the group consisting of Y₂O₃, La₂O₃, Sm₂O₃, Gd₂O₃ other rare earth oxides, CaO, Li₂O and combinations thereof.

9. The microwave tube material recited in claim 7 wherein said sintering aid comprises 0.25% and 10% of said composition by weight.

10. A method of manufacturing a high thermal conductivity, high strength material for use in high frequency evacuated electronic tubes; the method comprising the steps of:
a) preparing a homogeneous powder mixture of AIN and sintering aid wherein said sintering aid constitutes up to about 10% of said mixture by weight;
b) consolidating said mixture; and
c) densifying said consolidated mixture to a relative density of at least 95% of theoretical maximum density.

11. The method of manufacturing recited in claim 10 wherein the particle size of the AIN powder surface area is greater than 1.0 m²/g and the sintering aid powder surface area is greater than 3 m²/g.

12. The method of manufacturing recited in claim 10 wherein step a) is performed using at least one powder batching process taken from the group consisting of dry ball milling, slurry milling or high shear mixing and spray drying.

13. The method of manufacture recited in claim 10 wherein step b) is performed using at least one powder consolidating process taken from the group consisting of dry pressing, iso-pressing, slip casting, tape casting and gel casting.

14. The method of manufacturing recited in claim 10 wherein step c) is performed using at least one sintering process taken from the group consisting of hot pressing, hipping, gas-pressure sintering, microwave sintering and ambient pressure heating in a non-oxidizing inert atmosphere.
